(19) United States
(12) Patent Application Publication
(10) Pub. No.: US 2009/0211022 A1
(43) Pub. Date: Aug. 27, 2009

(54) Device for Supporting, Rolling and/or Rocking a Mattress

(76) Inventor: Lynda Joy Harding, Portsmouth (GB)

Correspondence Address: KLARQUIST SPARKMAN, LLP, 121 SW SALMON STREET, SUITE 1600, PORTLAND, OR, 97204, US

(21) Appl. No.: 11/922,902

(22) PCT Filed: Jun. 23, 2006
(86) PCT No.: PCT/GB2006/002329

§ 371 Date: Feb. 17, 2009

(30) Foreign Application Priority Data
Jun. 24, 2005 (GB) 0512901.0

(51) Int. Cl. A47C 21/00; A61G 7/00

(52) U.S. Cl. 5/110; 5/652; 5/655.7; 5/655.3

(57) ABSTRACT

A device for a cot or child's bed comprises a mattress support mounted on springs. Actuation means is provided to roll and/or rock the mattress support on the springs such that the side portions and/or the end portions of the mattress support repeatedly rise and fall. The actuation means could, for example, comprise a linear actuator, a swash plate mechanism or an air bag.

The present invention relates to a device for supporting, rolling and/or rocking a mattress and particularly but not exclusively relates to a device for supporting, rolling and/or rocking a mattress in a baby's or small child's cot.

It is desirable to provide a cot wherein the entire cot, or the cot mattress, moves in a way designed to facilitate sending a baby or small child to sleep.

It has been proposed to provide a cot comprising four horizontally orientated tension springs on top of which the cot mattress rests. Actuators are provided to stretch and release the springs to try to move the mattress.

It has also been proposed to provide a cot mounted on vertically orientated springs wherein the cot is provided with a separate, centrally mounted actuator which repeatedly pulls the centre of the mattress down in a cyclic motion.

It has further been proposed to provide a mattress pivotally mounted at one end to a bed frame and comprising an actuator at the other end of the mattress to move that end of the mattress up and down.

These previous proposals have been an integral part of a cot and are thus not suitable for use with a standard, pre-existing cot.

Additionally, the movement of the mattress provided by these prior proposals is unsatisfactory in terms of producing a soothing movement to send the child to sleep. These prior proposals comprise a single point actuator which generates a relatively harsh vibration that vibrates only one part of, or point of, the mattress, rather than a soothing movement of the entire mattress.

Such prior proposals typically also involve a relatively large number of parts and complexity leading to relatively high manufacturing and assembly costs.

According to a first aspect of the invention there is provided a device for supporting a mattress on a bed or cot or the like, the device comprising a mattress support on which the mattress rests in use, the mattress support being provided with spaced apart mounts which, in use, movably mount opposed portions of the mattress support on the bed or cot, the device further comprising actuation means operative to roll and/or rock the mattress support on the mounts such that the side portions and/or the end portions of the mattress support repeatedly rise and fall.

Preferably the mounts are orientated in a direction perpendicular to the plane of the mattress support.

Preferably the mounts are springs. Most preferably the mounts are coil springs.

Preferably the mattress support is rectangular, the mounts being spaced apart from the transverse axis of the mattress support.

Preferably the mounts are spaced apart from the longitudinal axis of the mattress support.

Preferably a mount is provided at each corner of the mattress support.

Preferably the actuation means comprises an actuator provided adjacent one side margin of the mattress support.

Preferably the actuator is adjacent one of the mounts.

Preferably the actuator is orientated in a direction perpendicular to the plane of the mattress support.

Preferably the actuation means comprises two actuators, the actuators being relatively spaced apart such that as one actuator moves one portion of the mattress support in one generally vertical direction, the other actuator moves an opposed portion of the mattress support in an opposed generally vertical direction.

The actuation means may be powered by a clockwork mechanism requiring no external power source.

The or each actuator may comprise an electrically operated actuator comprising an electromagnetic device or a DC stepping motor.

In an alternative embodiment the actuation means comprises a swash plate mechanism. Preferably the mattress support acts as the follower of the swash plate mechanism.

In a further alternative embodiment the actuation means comprises at least one air bag. In such an embodiment the air bag functions as the mount and actuation means.

Preferably the device further comprises adjustment means to adjust the rolling and/or rocking frequency of the mattress support. Preferably the adjustment means is operative to adjust the magnitude of the rolling and/or rocking of the mattress support.

Preferably the device further comprises means to compensate for the weight of the user being to one side of the longitudinal axis of the mattress so as to resist, in use, the mattress support tilting to one side about the longitudinal axis of the mattress support.

Preferably said means comprises at least one stopper operative to prevent full compression of at least one of the mounts.

Preferably audio means are provided to emit an audio stream during activation of the device.

According to a second aspect of the invention there is provided a bed or cot comprising the device of the first aspect of the invention.

Other aspects of the present invention may include any combination of the features or limitations referred to herein.

The present invention may be carried into practice in various ways, but embodiments will now be described by way of example only with reference to the accompanying drawings in which:

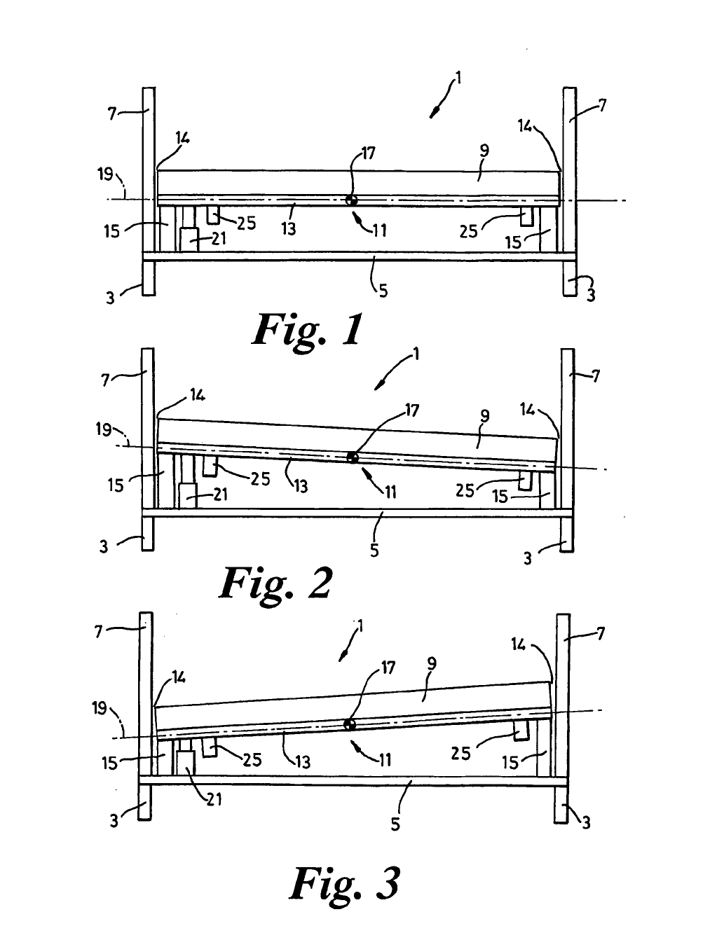

FIG. 1 is an end view of a device in accordance with the present invention in a rest condition;

FIG. 2 is an end view of the device of FIG. 1 in a first deflected condition;

FIG. 3 is an end view of the device of FIG. 1 in a second deflected condition;

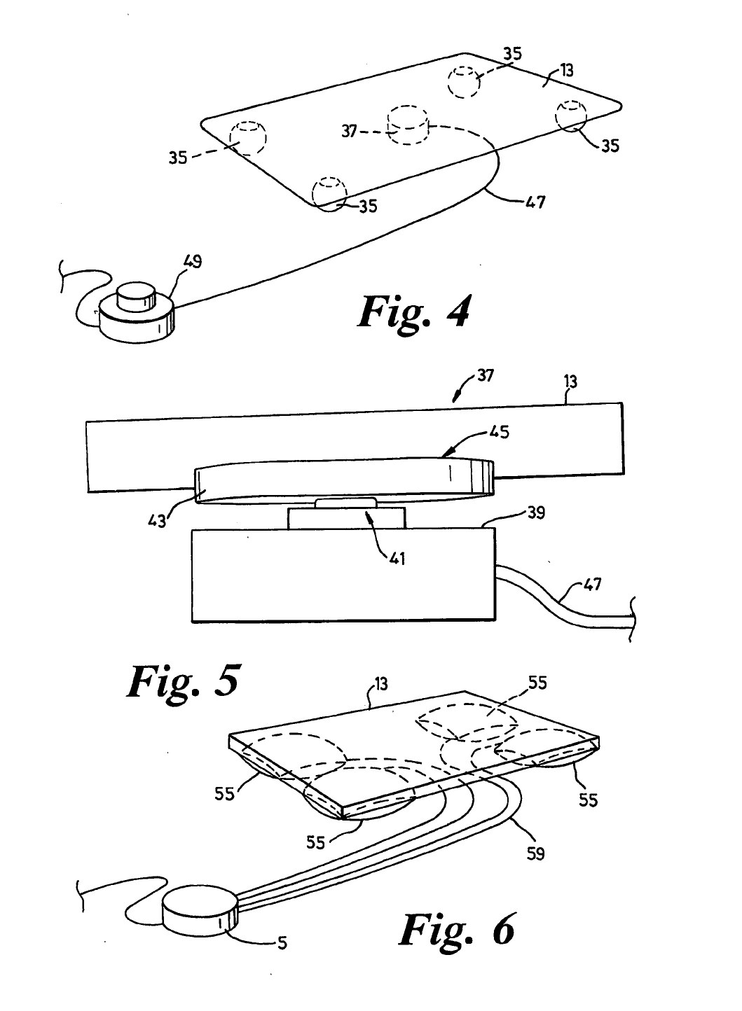

FIG. 4 is a perspective view of a modified device in accordance with the present invention;

FIG. 5 is a side view of part of the device of FIG. 4, and

FIG. 6 is a perspective view of a further modified device in accordance with the present invention.

Referring to the Figures, a standard cot 1 comprises four corner legs 3 supporting a horizontal, rectangular base frame 5 and upstanding side walls 7. The cot 1 further comprises a rectangular mattress 9 dimensioned, in ordinary use of the cot 1, to rest on top of the base frame 5 within the upstanding side walls 7.

A device indicated generally by 11 is provided for removable mounting on the base frame 5 underneath the mattress 9.

The device 11 comprises a planar, rectangular mattress support 13 dimensioned to fit within the upstanding side walls 7 with a clearance gap 14 between the outer margins of the mattress support 13 and the side walls 7.

The mattress support 13 can be provided with venting means in the form of apertures or channels to permit airflow through the mattress support 13, and can be in the form of, for example, a panel or a frame.

The underside of the mattress support 13 is provided, adjacent each corner, with four mounts in the form of coil compression springs 15 the upper ends of which are secured to the underside of the mattress support 13. The lower ends of the springs 15 rest, in use, on the base frame 5 of the cot 1. The position of the springs 15 may be adjusted to enable the mattress support 13 to be mounted in cots having different types or sizes of base frame.

The springs 15 are relatively spaced such that the mattress support 13 can roll from side to side about longitudinal mattress support axis 17 and/or rock from end to end about transverse mattress support axis 19. These motions can of course be simultaneous. The provision of springs 15 spaced apart in a direction along each axis of the mattress support 13 enables one margin of the mattress support 13 to rise simultaneously as the opposed margin of the mattress support 13 falls.

Actuation means comprising an actuator 21 is provided adjacent one side margin of the mattress support 13 and is mounted to the underside of the mattress support 13 inwardly from one spring 15. The lower end of the actuator 21 engages, in use, part of the base frame 5 of the cot 1. The actuator 21 is operative to impart motion on the mattress support 13. Control means (not shown) is provided to control the actuator 21. A luminous dial or display can be provided on the control means. The actuator 21 may comprise any suitable movement generator including an electronic device such as a DC stepping motor or an electromagnetic actuator. The actuator 21 could alternatively comprise a clockwork device (not shown) wherein the user can wind up a clockwork mechanism using a handle such that the winding energy is stored and released over a period of time to power the actuator 21. In that instance no external power source would be required. The control means can be positioned along a side margin of the device 1.

The device 1 is lowered, in use, into the cot 1 so that the springs 15, and the actuator 21, rest on the base frame 5 of the cot 1. The mattress support 13 is thus spaced from the base frame 5. The mattress 9 is then placed on top of the mattress support 13 so as to move with the mattress support 13.

In use, the control means is operative to activate the actuator 21 to repeatedly and sequentially compress the springs 15 at the side of the mattress support 13 adjacent the actuator 21. This rolls that side of the mattress support 13 downwardly under the influence of the actuator 21 and upwardly under the influence of the springs 15 at that side of the mattress support 13. Some of this movement is transmitted across the mattress support 13 and into the springs 15 at the other side of the mattress support 13 such that both sides of the mattress support 13 are cyclically moving up and down relative to the cot 1. As one side of the mattress moves upwardly, the other side of the mattress moves downwardly. This cyclic rolling motion of both sides of the mattress support 13 provides a particularly soothing and soporific effect to a child on the mattress 9 such that the child is more easily sent to sleep.

Additional actuators 21 can be provided adjacent some or all of the springs 15 to independently influence the movement of each spring 15. Therefore actuator(s) can be provided to effect a rocking motion of the mattress support 13 about transverse axis 19. The control means can be operative according to different programs to control the actuators 21 to exert different types of rolling and/or rocking motion on the mattress support 13. Thus a user will be able to select the program which works most effectively for their child. The control means can be programmable to enable a user to program a particular frequency/combination of the actuator(s) 21. The duration of activation of the device 1 can be raised/controlled. The device 1 may be sound activated so as to activate when the child cries.

The control means can also comprise an audio playback facility wherein a soothing audio stream such as music or a parent's voice can be played to the child as the mattress 9 rolls and/or rocks.

Compensating means can be provided to adjust the relative strength of some or all of the springs 15 to account for the child lying more towards one side of the mattress 9 than the other so as to resist the mattress 9 tilting to one side. The compensating means could comprise varying the spring rates using the actuators 21, or could comprise stoppers 25 mounted to the underside of the mattress support 13 to prevent the springs 15 being fully compressed. A mattress level sensor (not shown) could be provided in this regard.

The device 11 can be partially or fully waterproofed by coating the mattress support 13, the springs 15 and the actuators 21 in a waterproof coating or material. This could be achieved, for example, by securing a waterproof sheet (not shown) to the cot 1 below the mattress 9. This would also prevent access by the child to the springs 15 and the actuators 21.

Referring additionally to FIGS. 4 and 5, a modified device 1 is provided wherein the mattress support 13 is mounted on four mounts comprising air or gas filled spheres 35, a respective sphere 35 being positioned adjacent each corner of the mattress support 13. Each sphere can be made from a resiliently deformable material such as a rubber material.

Actuation means is provided comprising a swash plate mechanism 37 which comprises a motor and gearbox 39 that drives a vertical output shaft 41. A circular swash plate disc 43 is mounted on the shaft 41 with the plane of the disc 43 inclined to the axis of the shaft 41 such that the disc 43 is not horizontal. The upper surface of the disc 43 is received in a circular recess 45 formed in the underside of the mattress support 13 such that the disc 43 can rotate within the recess 45 so as to act as a cam. The motor 39 is connected to a power source via a cable 47 that is provided with a push button switch 49 although any other suitable activation means may alternatively be provided.

In use, the motor 39 rotates the shaft 41 which rotates the swash plate disc 43 within the recess 45. The inclined mounting of the swash plat 43 effects a cyclic rolling and rocking motion on the mattress support 13 which cyclically compresses and decompresses the spheres 35.

Referring to FIG. 6, an alternative device 1 comprises a mattress support mounted at each corner on a respective air bag 55. By air bag we mean any container that can be inflated or deflated by controlling the air pressure within the container and by air we include any gas.

Each air bag 55 is connected to an air/gas pump 57 by a respective conduit 59.

The pump 57 and air bags 55 can be controlled such that each air bag 55 can be inflated and deflated to achieve the desired movement of the mattress support 13. This movement could be a rolling movement from side to side of the support 13, a rocking movement from end to end of the support 13, or a combination of these two movements. The air bags 55 can also be controlled to raise or lower the mattress support 13 in a generally vertical direction. More than one pump could be provided.

Control valves could be provided to control the inflation and deflation of each air bag 55.

It will be appreciated that the alternative features described with reference to FIGS. 4 to 6 may be combined with, or replace, features of the device as described with reference to FIGS. 1 to 3.

1. A device for supporting a mattress on a bed or cot or the like, the device comprising a mattress support on which the mattress rests in use, the mattress support being provided with spaced apart mounts which, in use, movably mount opposed portions of the mattress support on the bed or cot, the device further comprising actuation means operative to roll and/or rock the mattress support on the mounts such that the side portions and/or the end portions of the mattress support repeatedly rise and fall.

2. The device of claim 1 wherein the mounts are orientated in a direction perpendicular to the plane of the mattress support.

3. The device of claim 1 wherein the mounts are springs.

4. The device of claim 3 wherein the mounts are coil springs.

5. The device of claim 1 wherein the mattress support is rectangular, the mounts being spaced apart from the transverse axis of the mattress support.

6. The device of claim 5 wherein the mounts are spaced apart from the longitudinal axis of the mattress support.

7. The device of claim 5 wherein a mount is provided at each corner of the mattress support.

8. The device of claim 1 wherein the actuation means comprises an actuator located adjacent one side margin of the mattress support.

9. The device of claim 8 wherein the actuator is adjacent one of the mounts.

10. The device of claim 8 wherein the actuator is orientated in a direction perpendicular to the plane of the mattress support.

11. The device of claim 8 wherein the actuation means comprises two actuators, the actuators being relatively spaced apart such that as one actuator moves one portion of the mattress support in one generally vertical direction, the other actuator moves an opposed portion of the mattress support in an opposed generally vertical direction.

12. The device of claim 1 wherein the actuation means is powered by a clockwork mechanism requiring no external power source.

13. The device of claim 8 wherein the actuator comprises an electrically operated actuator comprising an electromagnetic device or a DC stepping motor.

14. The device of claim 1 wherein the actuation means comprises a swash plate mechanism.

15. The device of claim 14 wherein the mattress support acts as the follower of the swash plate mechanism.

16. The device of claim 1 wherein the actuation means comprises at least one air bag.

17. The device of claim 1 further comprising adjustment means to adjust the rolling and/or rocking frequency of the mattress support.

18. The device of claim 17 wherein the adjustment means is operative to adjust the magnitude of the rolling and/or rocking of the mattress support.

19. The device of claim 1 further comprising means to compensate for the weight of the user being to one side of the longitudinal axis of the mattress so as to resist, in use, the mattress support tilting to one side about the longitudinal axis of the mattress support.

20. The device of claim 19 wherein said means comprises at least one stopper operative to prevent full compression of at least one of the mounts.

21. The device of claim 1 wherein audio means are provided to emit an audio stream during activation of the device.

22. An apparatus comprising a bed or cot in combination with the device of claim 1.
